(19) United States
(12) Patent Application Publication
(10) Pub. No.: US 2021/0160378 A1
(43) Pub. Date: May 27, 2021

(54) FINANCIAL SETTLEMENT SYSTEM FOR OWNER-OPERATED WIRELESS NETWORKS

(71) Applicant: Airwaive Inc., Dublin, CA (US)

(72) Inventor: Bin Zhu, Dollard-des-Ormeaux (CA)

(21) Appl. No.: 17/088,415

(22) Filed: Nov. 3, 2020

Related U.S. Application Data
(60) Provisional application No. 62/940,160, filed on Nov. 25, 2019.

(51) Int. Cl. H04M 15/00

(52) U.S. Cl. CPC H04M 15/51; H04M 15/8066

(57) ABSTRACT

A system and method that matches owner-operated wireless radios to a carrier network for voice and data services, using a marketplace model that geographically identifies and values the need for such radios and allows owners to claim rights to operate such radios. The purpose of the settlement system is to encourage individuals and businesses to operate a wireless radio to enhance a carrier network, establishing greater coverage and additional access points for wireless carriers, whilst the owner is compensated for the operations of one or more wireless radios based on radio usage. In the next generation of wireless networks, the number of wireless radios is expected to significantly increase, causing resource constraints for carriers to secure land and permits to install wireless radios. By utilizing the system, carriers may build networks faster by leveraging owners who assist with the installation and operation of radios, as an owner-operated network.

### REFERENCE TO RELATED APPLICATION

This application claims priority of U.S. Provisional Patent Application No. 62/940,160 filed on Nov. 25, 2019. The subject matter of this earlier filed application is hereby incorporated by reference in its entirety.

### FIELD OF THE INVENTION

This invention relates to a system and method for the provisioning, management and calculation of usage for owner-operated wireless radios such that the usage may be used to compensate the owner of such wireless radio. The system comprises of software that is connected to a wireless radio for its management and software that resides on a network server for operations and financial settlement.

### BACKGROUND OF THE INVENTION

Conventional wireless carrier networks are typically owned and operated by wireless carriers (“Carrier”) or they may be outsourced to a third party that has the responsibility for the installation and maintenance of wireless radios, including cellular antenna towers and the equipment that serves as the gateway to the core of the Carrier's network. As Carriers move to networks with faster wireless data speeds, additional wireless radios need to be built and operated to allow more points of entry to the network. To build new wireless radios, land is typically purchased or leased and permits are obtained by the Carrier. This is a time and capital consuming process for a Carrier.

By contrast, an owner-operated network of wireless radios allows individuals or businesses that own or have rights to the land they occupy, referred to here as Owners (“Owner”), to operate radios on behalf of Carriers and be compensated for such operation. A Financial Settlement System (“FSS”) is used to determine the amount Carriers are willing to spend for such operation in specific geographies, and split fairly across Owners operating the equipment based on wireless radio usage in a specified time period. The Financial Settlement System must be a trusted system between Carriers and Owners to ensure payments are made fairly and reduce the potential for fraud and abuse.

This approach to operating wireless networks, where wireless radio management is distributed across many Owners, has not been possible for adoption by Carriers until now due to the complexity of provisioning and managing wireless radios and the incentive system that encourages Owners to participate. When Wi-Fi technology was first being adopted in 2002, U.S. Pat. No. 6,795,700 was filed proposing a “Method of creating incentives for establishing hotspot locations”. Unlike cellular networks, which is monetized by Carriers, Wi-Fi is free for end users in most cases and an incentive system that shares revenue with owners is not applicable. Furthermore, the wireless reception range of Wi-Fi technology is generally shorter than cellular wireless range, thus it lacks central planning of radio placement. Cellular systems, by comparison, are designed to have continuous coverage in a geographic area, where radios have sufficient range to cover a defined cell sector. This difference for cellular planning requires consideration for the location of wireless radios and their installation onto a core carrier network. While U.S. Pat. No. 6,795,700 describes an incentive model for Wi-Fi access points, it failed to address a process for defining a geographic area and value for cellular coverage, and a process for Owners to claim and operate access points within the coverage area.

A related filing in 2005, U.S. Pat. No. 10,148,824, proposes an “Access point with controller for billing and generating income for access point owner”. Although the patent describes access points for cellular systems, it also lacks a method for Carriers to define a coverage area and for Owners to create and manage access points in alignment with policies from a Carrier. By comparison, the proposed invention creates a marketplace between Carriers and Owners, allowing market forces to govern the value and settlement for access point operations, including the ability for Carriers to create coverage areas and Owners to claim such areas.

### SUMMARY OF THE INVENTION

The present invention relates to a financial revenue-sharing settlement software platform for use in a cellular network comprising independently owned and operated radio access points that are geographically identified, valued and claimed.

In one embodiment, the present invention is a financial settlement system (FSS) which is a software platform that allows an Owner to specify a claim to install radio access network (“RAN”) equipment in a geographic area for wireless coverage, and upon award of such claim by a Carrier, calculates wireless data usage (“usage”) for each RAN, calculates the service level agreement (“SLA”) for each RAN, and reports the usage and SLA data to a settlement server for the calculation of financial compensation and settlement of such compensation to the RAN Owner. The usage of such RAN may be calculated based on total call minutes, total messages or total data bytes. SLA data is calculated based on metrics defined by a Carrier, including but not limited to RAN uptime, latency and data speed. Financial deductions for SLA violations provides motivation for Owners to operate RANs at their full capacity.

In one embodiment, the software for the registration of the RAN with the server and its calculation of usage and SLA data (“RAN SW”) is embedded as firmware in RAN hardware.

In another embodiment, the RAN SW is embedded as software within a RAN management system (“RMS”) which may be on separate hardware from the RAN, yet is connected to the RAN to perform operations.

In another embodiment, the software for the calculation of owner payments and its communication (“Settlement SW”) is embedded as software within the RMS.

In yet another embodiment, the Settlement SW is separated from the RMS, utilizing separate servers that connects to the RAN SW over a network.

In yet a further embodiment, the FSS includes the algorithms for the RAN SW and Settlement SW, which may be placed together or separately as software on wireless radios, within a carrier's network or the Internet.

### BRIEF DESCRIPTION OF THE DRAWINGS

FIG. 1 illustrates a geographic area defined by a Carrier as a cell sector.

FIG. 2 illustrates a cell sector that may be claimed by an Owner.

FIG. 3 is a high-level overview of the Carrier's network, consisting of a wireless device connecting to a RAN in a cell sector, a number (n) of wireless radios in a cell sector, with each RAN connecting to the Carrier's core network using a wired connection through a gateway, or a wireless connection to another wireless radio. The RANs connect to the FSS server to send usage and SLA data which is communicated to users of the FSS application.

FIG. 4 illustrates the embodiment where the software for calculating usage and SLA data (RAN SW) is connected into the RAN, either embedded within it or remotely, and connects to the software for calculating financial compensation and settlements for each RAN (Settlement SW).

FIG. 5 illustrates a single cell sector with a number (n) of RANs, also illustrating a number of users with wireless terminal devices (e.g. cellular phones) that connect to a RAN. Usage for each RAN is dependent on the number of users connected to the RAN. The figure illustrates a percentage of overall usage assigned to each RAN, labelled as X %, Y % and Z %, where the sum of percentages for all RANs in each cell sector will be equal to 100%. As an example, if the total usage in a cell sector with three RANs is 100 GB, and if RAN 1, RAN 2 and RAN 3 contribute 60 GB, 35 GB and 5 GB respectively, the percentages to each would be RAN 1=60%; RAN 2=35%; RAN 3=5%.

FIG. 6 is a diagram of the process used by the Carrier in the Settlement SW to create a cell sector.

FIG. 7 is a diagram of the process used by the Owner in the RAN SW and Settlement SW to claim a cell sector.

FIG. 8 is a diagram of the process used by the software in the RAN SW and Settlement SW to determine usage, calculate financial compensation and settlement.

### DEFINITIONS

Carrier is a wireless service provider that has the billing relationship with the consumer of the wireless terminal device.

Cell Sector is a defined geography that represents a coverage area of wireless service.

Digital Currency is electronic currency which is a balance that is stored in a distributed database on the Internet.

Fiat Currency is government-issued currency.

FSS is the complete financial settlement system that is comprised of two software components: RAN SW and Settlement SW.

Owner is an individual or business that has the rights to build and operate a wireless radio access network (RAN) and is compensated by the Carrier for the operation.

RAN is the Radio Access Network, or access point, between the wireless device and the core network, using a wired connection to such network or a wireless connection through one or more wireless radios in a mesh configuration to reach such network.

RAN SW is the software responsible for the registration of a RAN and the transmission of usage and SLA data to the Settlement SW.

RMS is RAN Management System responsible for managing the operations of a RAN.

Settlement SW is the software responsible for activating RANs in the platform, for communications between Carriers and Owners and for calculating the financial compensation for each RAN and settling compensation with the RAN Owner.

SLA is a Service Level Agreement that defines the key metrics for operating a RAN.

Token describes any digital value which is used as a means financial compensation, such as a country's local fiat currency.

### DETAILED DESCRIPTION OF THE INVENTION

The present invention consists of a method for Carriers to define a value and geographic boundary for a cell sector, which may be claimed by one or more Owners that operate RAN equipment in the cell sector, where such Owners are compensated based on the usage of each RAN and the value of the cell sector, otherwise referred to as the financial settlement system (FSS). The core of the system is a software algorithm that is separated into two parts: 1) the registration of a RAN and the calculation of usage and SLA data for each RAN, referred to as the RAN SW, and 2) the user interface portals and the calculation of financial compensation for each RAN, using data from the total assigned value of a cell sector and dividing this value across each RAN in such sector based on its contribution percentage of usage, otherwise referred to as the Settlement SW.

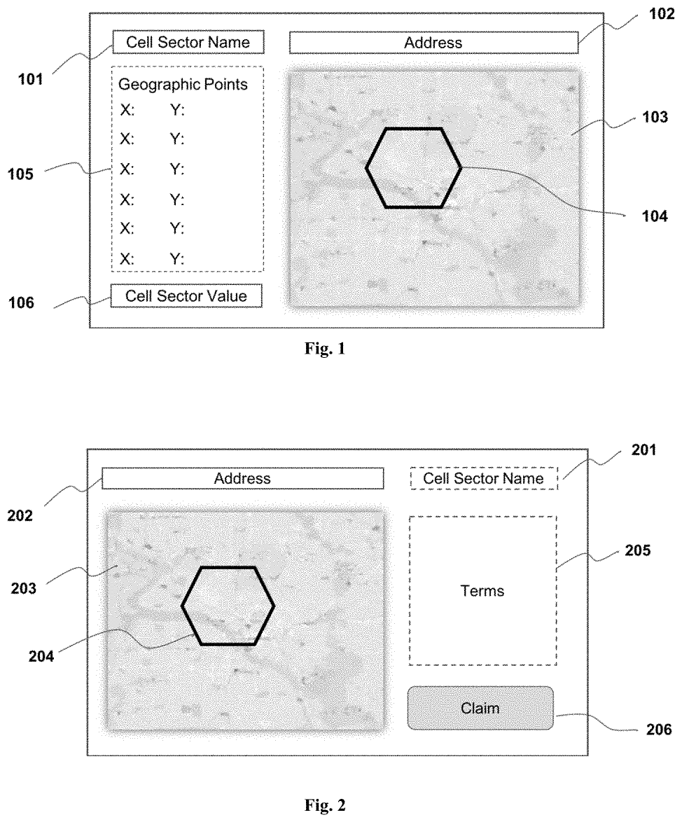

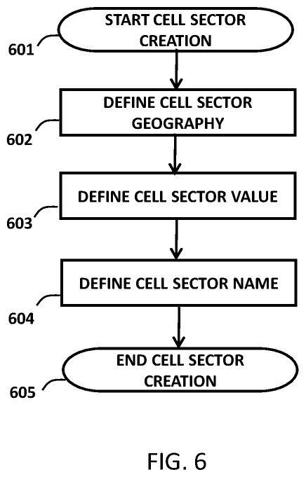

FIG. 1 describes the Carrier user interface where a Carrier user defines a cell sector. The user creates a unique name 101 for the cell sector and provides an address 102 for a focus area of the map 103. The user defines the geographic boundary for the cell sector using polygons 104 on the map. In one embodiment, the user defines the boundaries by adjusting the polygon shape by moving its vertices on the map. In another embodiment, the user defines the vertices by entering text for their geographic points 105. The user defines the value 106 of the cell sector as token (“tokens”), where such value may represent a local country's fiat currency (“fiat currency”) or an internationally-accepted digital currency (“digital currency”) which can be converted to the local currency for the Owner. In one embodiment, the user has predetermined the value of the cell sector and enters the amount. In another embodiment, the value of the cell sector is calculated based on the population within the geographic boundary of the cell sector and a revenue per person. FIG. 6 describes the algorithm used by the Settlement SW to save the defined geographic points 602, value 603, and name 604 of the cell sector. When the cell sector creation process is completed 605, the cell sector can be claimed by Owners. If an existing Owner with a location within the geographic points 602 is found in the Settlement SW, a notification is sent to the Owner to claim the cell sector. If an existing Owner is not found, or if the cell sector has not reached the maximum number of Owners, the geographic points 602 are used to determine addresses to target potential owners via automated marketing campaigns, such as location-based social media advertisements and emails.

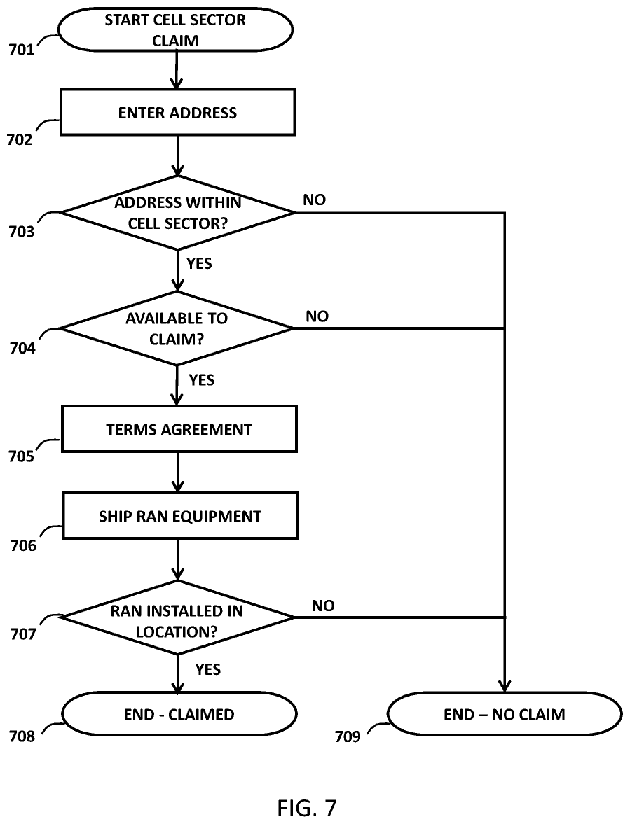

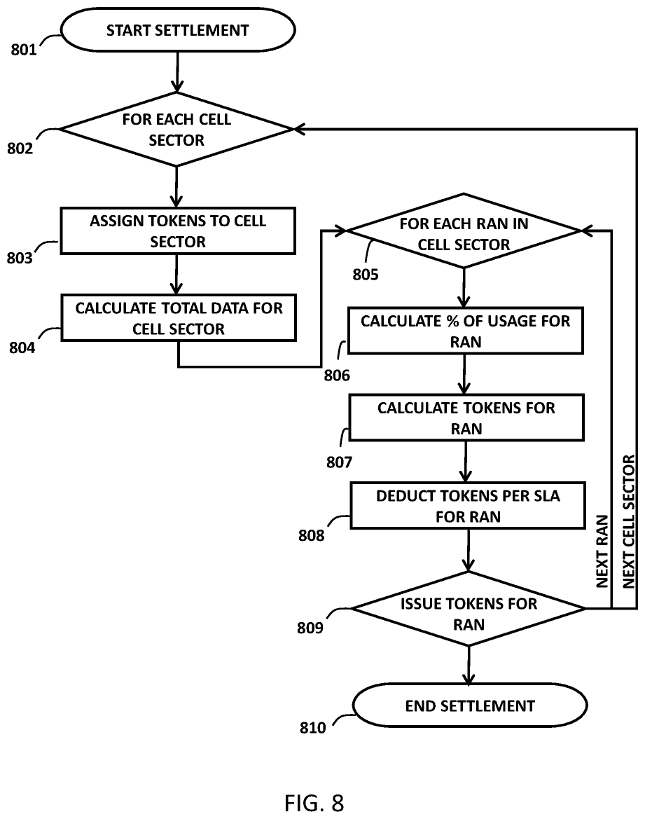

FIG. 2 describes the Owner user interface where an Owner user claims a cell sector. The user may enter a cell sector name 201, if it is known, otherwise it will appear after an address 202 is entered into the system. In one embodiment, a cell sector match is found based on the cell sector name 201 and then the map 203 and the polygon 204 representing the cell sector boundary are displayed. In another embodiment, a cell sector match is found based on the address 202, where such address is contained within the boundaries of the cell sector polygon 204. Upon such match, the Carrier terms 205 for the cell sector are displayed to the user for review before seeking the claim 206. FIG. 7 describes the algorithm used by the Settlement SW to preliminary save the claim, pending activation of RAN equipment. The Owner's address 702 is validated to be within the cell sector 703 before the user is allowed to proceed with a claim. As Carriers have rules for a variable number of Owners per cell sector, a check to validate that the cell sector is available to be claimed 704 is performed before the user is allowed to proceed with a claim. If the preceding checks 703 and 704 are allowed, the user is presented with terms 705 that are agreed to before the physical RAN equipment is acquired by the Owner 706.

FIG. 7 describes the completion of the steps after the Owner receives and installs the RAN equipment and connects it to the Carrier's core network. When the RAN equipment is connected to the network by the Owner, a unique identifier for the RAN and its location is sent to the RAN SW for validation 707. If the RAN equipment is successfully installed in a location within the cell sector, the claim is finalized 708 and the Owner is eligible for compensation. If the RAN equipment is not successfully installed, or installed in a location not within the cell sector, the claim is not completed 709 and the Owner is not eligible for compensation.

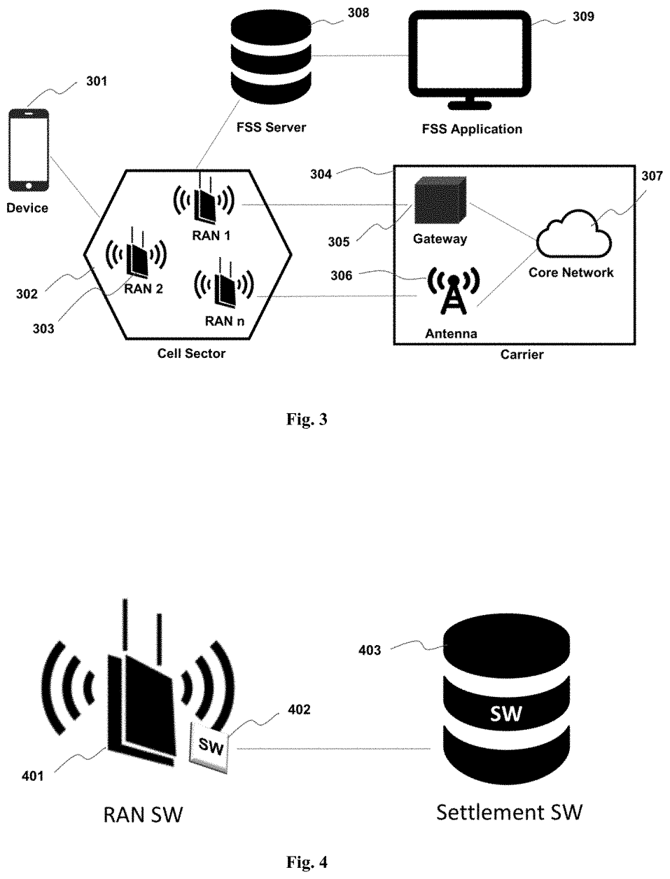

FIG. 3 describes a high-level overview of the network components when one or more RANs are successfully installed in a cell sector. A wireless device 301 in a cell sector 302 connects to a RAN 303 to access the Carrier's network 304. A RAN may connect over a wired connection to a Gateway 305 or a wireless connection to an antenna 306 to access the core network 307. This connection results in usage from the wireless device 301 which is captured by the FSS server 308 and may be viewed in the FSS application 309.

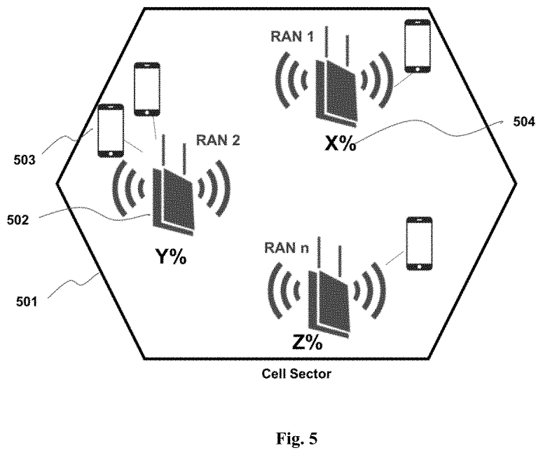

FIG. 4 further describes the components of the FSS, which is a software system comprised of the RAN SW 402 and Settlement SW 403. In one embodiment, the RAN SW is embedded in the RAN hardware equipment 401. In another embodiment, the RAN SW is embedded in a RAN Management System (RMS). In one embodiment, the Settlement SW is embedded in the RAN Management System (RMS). In another embodiment, the Settlement SW is embedded in a server with connectivity to the RAN SW.

FIG. 5 describes the process to determine usage for each cell sector 501 and to each RAN in such cell sector. In a cell sector 501, one or more RANs 502 supply the access point to the core network for one or more wireless devices 503. For purpose of illustration, three RANs labeled RAN 1, RAN 2 and RAN n exist in the cell sector in FIG. 5 with one wireless device connected to RAN 1, two wireless devices connected to RAN 2 and one wireless device connected to RAN n. Each RAN is assigned a usage percentage 504 which is determined based on the usage from wireless devices connected to the RAN. For the purpose of illustration, the three RANs listed in the example figure have percentages of X %, Y % and Z % which are calculated by the Settlement SW. Each RAN communicates its usage via the RAN SW to the Settlement SW for the calculation.

FIG. 8 describes the algorithm in the Settlement SW for the settlement process, determining the compensation for each Owner. It is performed for each cell sector, and for each RAN in each cell sector, until all RANs have been calculated and tokens distributed to the Owners of each RAN. At a specified time period, such as monthly, the settlement process begins 801. For each cell sector 802, the following is performed:

The Settlement SW assigns a number of tokens 803 for each cell sector proportional to the pre-assigned value for the cell sector 603 by the Carrier.

The total usage is calculated across the cell sector 804 as the summation of all RAN usage sent by the RAN SW 402 in the cell sector.

For each RAN in the cell sector 805, the following is performed:
a. The usage data for the RAN 503 is determined as a percentage 504 of the overall usage for the cell sector. The calculation 806 is performed by dividing the RAN usage by the total cell sector usage. As an example, if the total usage for the cell sector across all RANs is 100 GB, and one RAN's usage is 25 GB, the calculation would be 25% (25 GB/100 GB).
b. The number of tokens for the RAN 502 is determined. The calculation 807 is performed by multiplying its usage percentage from the previous step 806 by the total number of tokens for the cell sector 803. As an example, if the total tokens for the cell sector is 20,000 and one RAN's percentage is 25%, the calculation would be 5,000 tokens (25%*20,000). If a minimum number of tokens is set, the greater of the calculated number and the minimum number is used. As an example, if the minimum tokens is 2,000 tokens and the calculated value is 5,000 tokens, then the number of tokens for the RAN 502 is 5,000 tokens.
c. Tokens are subtracted for SLA violations to arrive at the final number of tokens for the RAN, based on the SLA terms 205 agreed to by the Owner and the reported SLA data by the RAN SW 402. The calculation 808 is performed by subtracting tokens from the previous step 807 by an amount specified in the terms 205. As an example, if the terms of the SLA deduct 1,000 tokens for an SLA availability metric of 98%, and the RAN's total tokens before deduction is 5,000 tokens, then the final compensation for the Owner would be 4,000 tokens (5,000−1,000).
d. Tokens are issued to the Owner of the RAN 809 based on the final calculation of tokens 808.
e. The process repeats for each RAN 805 until it is the last RAN in the cell sector. Upon completing the last RAN in the cell sector, it proceeds to the next cell sector 802.

The process repeats for each cell sector 802 until it reaches the last cell sector. When completing the last RAN in the last cell sector, the process ends 810.

1. A method to identify and value wireless cell sectors for financial compensation to Owners of individual wireless radio access network (RAN) equipment in a wireless network, comprising the steps of:
a. creating a geographically defined wireless cell sector and assigning the cell sector a monetary value;
b. claiming the wireless cell sector and activating the claim after the installation of RAN equipment;
c. assigning a percentage of the monetary value of the cell sector to each RAN in a designated cell sector;
d. transferring the monetary value of each RAN to the owner of the RAN.

2. The method of claim 1, wherein the user defines the geographic boundary of the cell sector area in part a) by adding points in a coordinate system to specify the polygon boundaries.

3. The method of claim 1, wherein the user defines the geographic boundary of the cell sector area in part a) by modifying polygon vertices with a touch device to specify the polygon boundaries.

4. The method of claim 1, wherein a predetermined monetary value of the cell sector in part a) is entered by the user into the user interface.

5. The method of claim 1, wherein the monetary value of the cell sector in part a) is calculated based on the population of people within the geographic boundary of the cell sector and a defined revenue per person.

6. The method of claim 1, wherein the claiming of part b) comprises a claim identification further comprising an address match within the geographic boundary of a cell sector with an existing user's address, and such user is notified to accept the wireless cell sector claim.

7. The method of claim 1, wherein the claiming of part b) comprises a claim identification further comprising a search for potential users with address locations within the geographic boundary of a cell sector using digital advertisements, and such users are presented with the terms of the wireless cell sector claim.

8. The method of claim 1, wherein claiming of part b) comprises a claim identification further comprising the user entering an address for a potential RAN installation, and such address must be within the geographic boundary of a cell sector to be eligible.

9. The method of claim 1, wherein the claiming of part b) comprising a claim identification further comprising a system check ensuring that the cell sector is available for RAN installation for the user to be eligible.

10. The method of claim 1, wherein the claiming of part b) comprises user agreement to the terms and conditions for RAN operations to be eligible.

11. The method of claim 1, wherein the installation of RAN equipment of part b) is a precondition for the RAN to be activated for financial compensation.

12. The method of claim 1, wherein the installation of RAN equipment of part b) in a location outside of the designated geographic boundary of the cell sector deactivates the RAN for financial compensation.

13. The method of claim 1, wherein the identified claim for a cell sector in part b) is expired and removed from eligibility if RAN equipment is not successfully installed within a specified time period.

14. The method of claim 1, wherein the assignment of a monetary value in part c) for a RAN is based on the RAN's usage percentage within the cell sector, by calculating the usage of a RAN in a specified time period divided by the total usage of all RANs in the cell sector in the same time period, multiplied by the total monetary value of the cell sector.

15. The method of claim 1, wherein the assignment of a monetary value in part c) for a RAN is based on a fixed value by dividing the total monetary value of the cell sector by the total number of all RANs in the cell sector.

16. The method of claim 1, further comprised of a method to calculate the final monetary value of the RAN in part c) by subtracting a value for violations of service level terms.

17. The method of claim 1, wherein the monetary value transferred to the Owner of the RAN in part d) is represented by digital tokens.

18. The method of claim 1, wherein the monetary value transferred to the Owner of the RAN in part d) is a fiat currency.

19. The method of claim 1, wherein the monetary value transferred to the Owner of the RAN in part d) is an established digital currency.

20. A system for identifying, valuing and claiming wireless cell sectors for owner-operated wireless access points, and for financial settlement of such operations, the system comprising:
a. a wireless radio access network (RAN);
b. a RAN software module comprising logic to activate an owner-operated RAN for financial compensation and determine usage of such RAN;
c. a settlement software module comprising a user interface and logic to create, value and claim wireless cell sectors and for financial compensation to Owners of RAN equipment.

21. The system of claim 20, wherein the RAN software module of part b) is executed by a processor on the RAN.

22. The system of claim 20, wherein the RAN software module of part b) is executed by a processor on the RAN Management System (RMS).

23. The system of claim 20, wherein the settlement software module of part c) is executed by a processor on the RAN Management System (RMS).

24. The system of claim 20, wherein the settlement software module of part c) is executed by a processor external to the RAN Management System (RMS) with an interface to communicate with said RMS.
